(19) United States
(12) Patent Application Publication
(10) Pub. No.: US 2017/0286411 A1
(43) Pub. Date: Oct. 5, 2017

(54) Methods For Upload And Compression

(71) Applicants: Ivan Ablamsky, Kiev (UA); Denys Misko, Kiev (UA)

(72) Inventors: Ivan Ablamsky, Kiev (UA); Denys Misko, Kiev (UA)

(21) Appl. No.: 15/089,072

(22) Filed: Apr. 1, 2016

(51) Int. Cl. G06F 17/30; H04L 29/08

(52) U.S. Cl. CPC G06F 17/301; H04L 67/06

(57) ABSTRACT

The present invention is generally related to compression for dividing files into one or more components (or parts), checking for the existence of a part at the receiver prior to transmitting the one or more parts, and deciding not to transmit the part if the receiver already has the part. Additional embodiments of the present invention utilize a similar method to reduce the space required for storage by turning a file for storage into components (or parts), checking for the existence of a part in storage prior to storing the part, and storing a reference to the preexisting part instead of a duplicate of the part if the part already exists in storage.

### BRIEF DESCRIPTION OF THE INVENTION

The present invention is generally related to compression for turning files into one or more components (or parts), checking for the existence of a part at the receiver prior to transmitting the one or more parts, and deciding not to transmit the part if the receiver already has the part. Additional embodiments of the present invention utilize a similar method to reduce the space required for storage by turning a file for storage into components (or parts), checking for the existence of a part in storage prior to storing the part, and storing a reference to the preexisting part instead of a duplicate of the part if the part already exists in storage.

### CROSS-REFERENCES TO RELATED APPLICATIONS

Not applicable.

### STATEMENTS AS TO THE RIGHTS TO INVENTIONS MADE UNDER FEDERALLY SPONSORED RESEARCH OR DEVELOPMENT

Not applicable.

### REFERENCE TO A “SEQUENCE LISTING,” A TABLE, OR A COMPUTER PROGRAM LISTING APPENDIX SUBMITTED ON A COMPACT DISK.

Not applicable.

### BACKGROUND OF THE INVENTION

The increasing prevalence of Internet-accessible storage has led users and businesses to develop applications for that storage. One such application involves per-user storage of, and access to, files such as music and video files. In theory, a user storing his or her media collection on Internet-accessible storage would be able to access the user's media (music, video, or the like) from any Internet connected device, such as a computer, smartphone, tablet, etc.

Certain practical problems, however, inhibit the use of Internet-accessible storage for such media storage. Wide area network (WAN) connections, such as Internet connections, tend to be significantly slower than, for example, local area network (LAN) connections. A typical LAC connection may operate at tens of gigabits, while a typical WAN connection may max out at tens of megabits. At the same time, a media collection is typically tens of gigabytes in size, and may in many cases reach several terabytes in size.

Assuming that a user can dedicate a network connection for the hours, or days, it may take to upload a sizable media collection, existing storage services may not be able to accommodate petabytes (or even exabytes) of stored media in a cost-effective or competitive manner.

There is, therefore, a need for methods and apparatus that expedite the uploading and storage of such media files to allow digital media storage services to operate competitively.

### BRIEF DESCRIPTION OF THE SEVERAL VIEWS OF THE DRAWING

FIG. 1 illustrates a general overview of an apparatus which may be utilized to carry out the herein disclosed methods for file upload and compression in accordance with the present invention; and

FIG. 2 illustrates the steps of an exemplary embodiment of the herein disclosed methods for file upload and compression in accordance with the present invention.

### DETAILED DESCRIPTION OF THE INVENTION

An exemplary and preferred embodiment of the herein disclosed method for uploading a media file to storage comprises the steps of: computing a value relating to at least part of the media file for upload; uploading the value prior to uploading the associated part of the media file; receiving an indication as to whether the associated part of the media file is already present in storage based on the uploaded value; and cancelling the upload of the media file if the uploaded value indicates that the associated part of the media file is already present in storage.

A related and exemplary embodiment of the herein disclosed method for storing a media file comprises the steps of: computing a value relating to at least part of the media file for storage; consulting the storage using the computed value to see if the associated part of the media file is already present in storage; and replacing the associated part of the media file for storage with a reference to already stored data when the associated part of the media file is already present in storage.

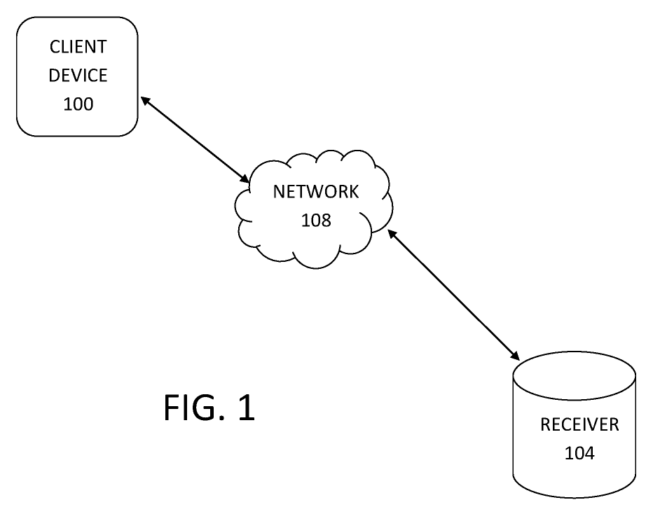

In accordance with the present invention, FIG. 1 illustrates a user operating a client device 100 (such as a desktop computer, a laptop computer, a smartphone, or any other like device known in the art) desires to transmit a file, such as a media file, to a receiver 104 by way of network 108. The file may be a video file, a music file, an application file, a program file, an informational document file, an image file, a database file, or any other digital file known in the art. The receiver 104 may be a network-connected storage service, such as a service for storing media files owned by, or in possession of, one or more customers (or subscribers or users) communicatively connected to the storage service. In some embodiments, the receiver 104 may be a desktop computer, a laptop computer, a server computer, a virtual machine, or the like as is known in the art.

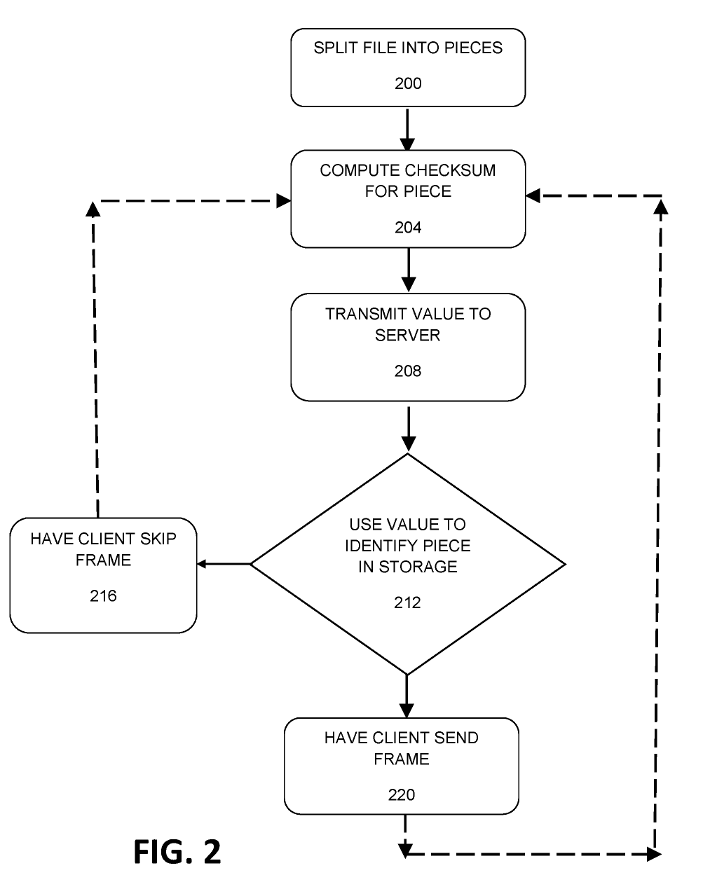

Looking to FIG. 1 and FIG. 2, client 100 spits the file for upload into two or more pieces (which may be referred to as parts or portions) in Step 200. Prior to uploading one part of the two or more parts, client device 100 computes a value for the part, such as a checksum or hash value, for example, in Step 204 and transmits the value to server 104 in Step 208.

Every file may consist of two parts, a metadata part and a media data part. According, Step 204 may include calculation (or determination) of up to three separate checksum (or hash value) calculations: a first checksum for the whole file, a second checksum for the media data part, and a third checksum for the metadata part. For example, music files may consist of a PCM part, and an ID3 part, as is known in the art. In the example, the herein disclosed method may determine (or calculate) a checksum for the PCM part, a separate checksum for the ID3 part, and a separate checksum for the entire music file.

Checksum(s) many be calculated with typical algorithms (such as SHA1 or MD5, as is known in the art) or non-typical algorithms. For example, some media data files can be very large and therefore take up much space and require significant time for calculating one or more checksums. If that is the case, then the herein disclosed methods can calculate checksums of various chucks (of predetermined or specific sizes) of the overall media data file. For example, if a media file is 10 gigabytes in size, the server can send instructions to the client to calculate checksums of five separate chunks of the media file with, for example, one megabyte offsets to the beginning, middle, and end of the file. In this example, the herein disclosed method can then check each of the five chunks against identically situated chucks of a previously stored file to determine whether the file exists in storage and then determine not to upload the file.

Server 104, after receiving the value, determines whether it already has the part in its local storage in Step 212. In one embodiment, for example, server 104 maintains a list of values associated with each of the parts it has in storage and compares the received value against the list of values. If server 104 finds a match for the received value, then the server 104 knows that it has the part in storage and sends instructions back to client 100 telling it to skip the transmission of that particular part, in Step 216. If server 104 does not have the part, then it instructs the client to transmit the part, in Step 220.

The above described process, or method, may be repeated for each and every part of the file, or alternatively the process may continue until a particular number of parts from the file are identified as present at server 104. In either case it may be inferred that the file is already present on server 104 and the upload of the file may be aborted in its entirety. Accordingly, embodiments of the present invention can greatly reduce the amount of data transmitted from client 100 to server 104 in the course of uploading files.

In various embodiments of the present invention, the methods for splitting a file into two or more parts and computing the differences between various parts may relate to the particular kind of content (whether the file is an audio file, a video file, an image, or a documents, for example), as is known in the art. The particular method may alternatively, or additionally, depend on the content container type (the audio or video codec, or the image format, for example), as is known in the art.

The number of parts, and the size of each part, that a file may be broken into can be variable depending on various factors including, but not limited to, network connection characteristics, file characteristics, predetermined parameters, device types, operating environment, or other factors as are known in the art.

Related embodiments of the present invention may utilize a variant of the above described method for compression to reduce the amount of space required to store files in memory. As discussed above, breaking (or dividing) a file into pieces and transmitting values associated with those pieces allows a client to avoid the uploading of files already present on the receiving computer.

If the receiving computer is providing storage services for a plurality of users, then the receiving computer can consult the entirely of its storage in connection with the upload process to determine whether any file (or any piece of a file) stored for any user on the receiving computer is a match for the file (of piece of the file) that the particular user is attempting to upload. If a match is found, then the various matching pieces can be de-duplicated and replaced by a reference to the one or more matching pieces in storage.

The method need not be restricted to uploaded data. If can be extended to any data added to storage, either through uploading or otherwise (such as direct transfer from one computer or system to anther communicatively connected computer or system). The process can be performed at the level of individual parts instead of entire files.

Certain files may have similar or identical substantive data while having varying sets of properties or metadata, as is known in the art. For example, various audio or video files may have the same encoded content but have different properties specifying, for example, a genre or source of origin. The underlying encoded content would be identical among the various files, but the metadata associated with the files would be different.

If each of these substantively identical files were added to a storage service in accord with the herein disclosed methods, then the storage service would identify the identical nature of the content and the differing metadata, split the content from the metadata, and save each set of metadata associated with the content, but only one copy of the underlying (substantive) content after identifying the presence of a duplicate file already in storage as discussed above.

Generally speaking, embodiments of the present invention can copy and store the metadata associated with a file while replacing the underlying substantive data with a reference to another identical file (or part thereof) located elsewhere in storage. When the time comes to transmit or otherwise decompress the file, the reference to the identical file is replaced with the file's substantive data and merged with the stored metadata, rendering the decompression process transparent.

While the present invention has been illustrated and described herein in terms of a preferred embodiment and several alternatives, it is to be understood that the techniques described herein can have a multitude of additional uses and applications. Accordingly, the invention should not be limited to just the particular description and various drawing figures contained in this specification that merely illustrate a preferred embodiment and application of the principles of the invention.

What is claimed is:

1. A method for uploading a media file to storage, the method comprising:
computing a value relating to at least part of the media file for upload;
uploading the value prior to uploading the associated part of the media file;
receiving an indication as to whether the associated part of the media file is already present in storage based on the uploaded value; and
cancelling the upload of the media file if the uploaded value indicates that the associated part of the media file is already present in storage.

2. A method for storing a media file, the method comprising:
computing a value relating to at least part of the media file for storage;
consulting the storage using the computed value to see if the associated part of the media file is already present in storage; and
replacing the associated part of the media file for storage with a reference to already stored data when the associated part of the media file is already present in storage.
